(19) United States
(12) Patent Application Publication
(10) Pub. No.: US 2014/0081517 A1
(43) Pub. Date: Mar. 20, 2014

(54) ELECTRONIC DEVICE FUNCTIONALITY MODIFICATION BASED ON SAFETY PARAMETERS ASSOCIATED WITH AN OPERATING STATE OF A VEHICLE

(71) Applicant: CLOUDCAR, INC., Los Altos, CA (US)

(72) Inventors: Peter Barrett, Palo Alto, CA (US); Konstantin Othmer, Los Altos, CA (US); Bruce Leak, Los Altos Hills, CA (US)

(73) Assignee: CLOUDCAR, INC., Los Altos, CA (US)

(21) Appl. No.: 13/623,683

(22) Filed: Sep. 20, 2012

(51) Int. Cl. G06F 17/00

(52) U.S. Cl. 701/36

(57) ABSTRACT

In an example, a method of modifying functionality of an electronic device associated with a vehicle may include assessing one or more safety parameters associated with an operating state of a vehicle. The method may further include modifying functionality of an electronic device associated with the vehicle based on the one or more safety parameters.

### FIELD

Example embodiments described herein relate to the modification of functionality of an electronic device associated with a vehicle based on safety parameters associated with an operating state of the vehicle.

### BACKGROUND

Many consumers own mobile electronic devices (referred to as “mobile devices”) with functionality that may allow the consumers to perform countless tasks and may provide the consumers with boundless information or media wherever the consumer may be. For example, mobile phones, smartphones, laptop computers, tablet computers, portable navigation systems, and personal data assistants (PDAs) are all mobile devices that are increasingly versatile and mobile.

Additionally, modern vehicles have built-in electronic devices (referred to as “vehicular devices”) which provide information to the occupants of the vehicles. For example, many vehicles include navigation systems, stereo systems, video systems, mobile device interfaces, etc. that may allow occupants of the vehicles to access information and media. However, the use of mobile devices and/or vehicular devices while operating a vehicle can lead to operator distractions and potentially dangerous operating conditions.

In addition to providing the driver with information, the vehicular and/or mobile electronic devices may require input from the driver to perform some actions. For example, a stereo system may require the driver to interact with an interface to change the volume, change the radio station, or switch between CDs. Similarly, a mobile phone may require the driver to interact with a touchscreen or keypad to view or respond to a text message, receive a phone call, and/or access an application.

These applications and services require the driver's attention, some more than others. For example, changing the volume on a radio can be done without taking one's eyes off the road, but selecting a contact to call from a mobile phone address book requires looking at the phone, not the road. Similarly, entering an address into a navigation system requires focused effort. This sort of “distracted driving” has caused accidents and many states now have laws forbidding interacting with mobile phones while driving. The National Highway Traffic Safety Administration (NHSTA) has provided guidelines to automakers to make sure that new cars discourage distracted driving. The focus of the NHSTA guidelines is to encourage drivers to keep their eyes on the road rather than being distracted with the interface of a mobile device or vehicular device. As a result, car system manufacturers often disable features unless the car is in a parked mode, and require the operator to accept various disclaimers to not use a product while driving. The NHSTA guidelines are often in direct conflict with drivers' desired behavior.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

Some embodiments described herein generally relate to limiting the functionality of a mobile electronic device or a vehicular device based on the operating state of a vehicle. Accordingly, the embodiments described herein generally relate to modifying the functionality of electronic devices associated with a vehicle based on safety parameters associated with operating the vehicle. As described in detail, the safety parameters may be based on any number of operating conditions including a speed of the vehicle, traffic congestion surrounding the vehicle, a weather condition, a road condition, a proximate location of an emergency vehicle, a proximate location of a school zone, road type, presence of a passenger in the vehicle and/or a proximate location of a pedestrian, a cyclist, another vehicle, a road hazard, a construction cone, a barrier, an animal etc. Accordingly, the functionality of the electronic devices may dynamically change according to the safety parameters.

Therefore, the operator of the vehicle may not be able to utilize some functionality of electronic devices while operating the vehicle in particularly unsafe situations while also being able to utilize the functionality if the conditions are deemed to be substantially safe. As such, driver distraction may be reduced while also allowing functionality of the electronic devices at different times instead of having the electronic devices in a static state during operation of vehicle.

In an example embodiment, a method of modifying functionality of an electronic device associated with a vehicle is described. The method may include assessing one or more safety parameters associated with an operating state of a vehicle. The method may further include modifying functionality of the electronic device associated with the vehicle based on the one or more safety parameters.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example vehicle configured to assess one or more safety parameters associated with an operating state of the vehicle;

FIG. 2 is a block diagram of a specific embodiment of an operating environment associated with the vehicle of FIG. 1;

FIG. 3 is a block diagram of an example vehicular control system, a mobile device, and a vehicular device that may be implemented in the operating environment of FIG. 2 and the associated vehicle of FIG. 1; and

FIG. 4 is a flowchart of an example method 400 for modifying functionality of an electronic device based on one or more safety parameters associated with an operating state of the vehicle.

### DETAILED DESCRIPTION OF SOME EXAMPLE EMBODIMENTS

In some embodiments of the present disclosure, a vehicle may be configured to assess one or more safety parameters associated with an operating state of the vehicle. Based on the one or more safety parameters, functionality of one or more electronic devices associated with the vehicle may be modified. In some embodiments, the modifications of the electronic device may be done in varying degrees depending on the assessment of the one or more safety parameters.

For example, a vehicle may be configured to assess one or more safety parameters such as a speed of the vehicle, traffic congestion surrounding the vehicle, a weather condition, a road condition, a proximate location of an emergency vehicle, a proximate location of a school zone, road type, presence of a passenger in the vehicle and/or a proximate location of a pedestrian, a cyclist, another vehicle, a road hazard, a construction cone, a barrier, an animal etc. The safety parameters may indicate a situation where particular attention may be made to operating the vehicle instead of interacting with a mobile phone, vehicular infotainment system, or other electronic devices located within the vehicle. Accordingly, in such situations at least a portion of the functionality of the one or more electronic devices may be temporarily restricted to help the operator of the vehicle maintain focus on operating the vehicle. For instance, alerts typically given by a mobile phone which are associated with incoming text or email messages or phone calls may be temporarily suppressed or otherwise restricted. In contrast, if one or more safety parameters indicate that it may be relatively safe to interact with the electronic device, the functionality of the one or more electronic devices may be less restricted and/or fully enabled.

Reference is now made to the drawings to describe various aspects of some example embodiments of the present disclosure. The drawings are diagrammatic and schematic representations of such example embodiments, and are not limiting of the present disclosure, nor are they necessarily drawn to scale.

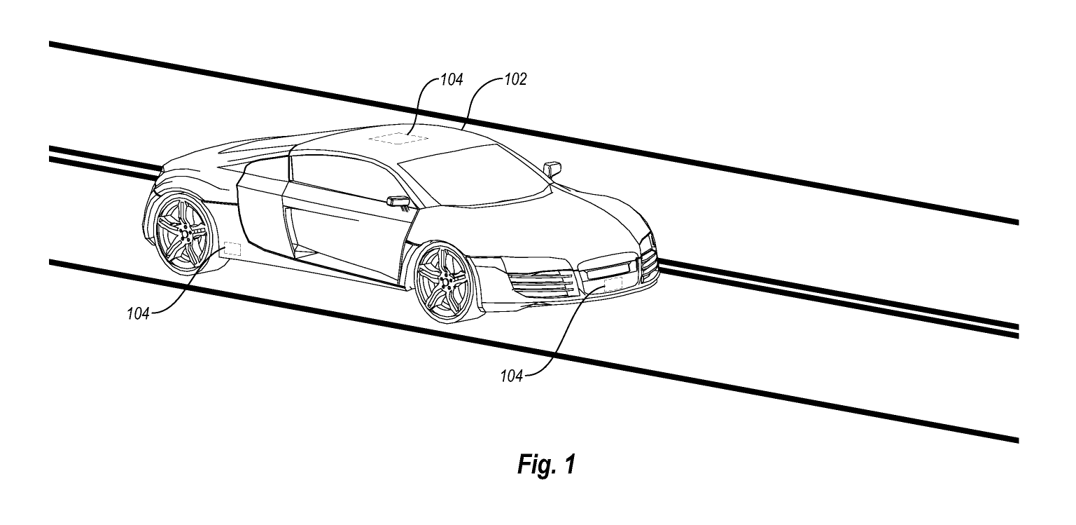

FIG. 1 illustrates an example vehicle 102 configured to assess one or more safety parameters associated with an operating state of the vehicle 102, according to one or more embodiments of the present disclosure. Although illustrated as an automobile, the vehicle 102 may more generally include any vehicle in which it may be desirable to modify the functionality of one or more electronic devices (hereinafter “electronic devices”) associated with the vehicle based on one or more assessed safety parameters. Generally, for example, the vehicle 102 may include a motorized vehicle such as a car, a truck, a motorcycle, a tractor, a semi-tractor, an airplane, a motorized boat, or the like, or even a non-motorized vehicle such as a bicycle, a wheelchair, a sailboat, or the like—provided that suitable components may be present.

The vehicle 102 may include one or more sensors 104 configured to measure one or more conditions associated with the environment surrounding the vehicle 102 and/or one or more operating conditions of the vehicle 102. For example, the sensors 104 may be configured to determine a location of the vehicle 102, a speed of the vehicle 102, outside temperature surrounding the vehicle 102, the presence or absence of precipitation, a proximate location of one or more objects with respect to the vehicle 102 (e.g., people, animals, other motorized vehicles, other non-motorized vehicles, road hazards, construction cones, barriers, etc.), a condition of the transportation medium being travelled on (e.g., a wet road, a dry road, a bumpy road, a smooth road, an icy road, an oily road, etc.), or any other applicable condition that may be measured by a sensor. Accordingly, the sensors 104 may include, but are not limited to, a camera, a radar system, a radio system, a global positioning system (GPS), a speedometer, a sonar system, a radar system, an accelerometer, a thermometer, a laser sensing system, a rain sensor, an ice detector, a sound detector, a light sensor, a pressure sensor, a heat sensor, or any other suitable system, apparatus, or device that may assess information regarding the environment surrounding the vehicle 102 and/or the operating conditions of the vehicle 102.

The measurements made by the sensors 104 may be used to assess one or more safety parameters associated with the operating state of the vehicle 102. For example, the measurements made by the sensors 104 may be used to determine one or more safety parameters such as, but not limited to, the speed of the vehicle 102, traffic congestion surrounding the vehicle 102, a weather condition, a road condition, a proximate location of an emergency vehicle, a proximate location of a school zone, road type, presence of a passenger in the vehicle 102 and/or a proximate location of a pedestrian, a cyclist, another vehicle, a road hazard, a construction cone, a barrier, an animal etc.

Based on the assessed safety parameters, a processing device of the vehicle 102 may determine a threat risk assessment and may accordingly modify the functionality of one or more electronic devices associated with the vehicle 102 based on the assessed safety parameters and the corresponding risk assessment. In some embodiments, the risk assessment may be based on a threshold associated with the safety parameters such that the electronic devices may be disabled or enabled based on whether the threshold has been exceeded or not.

For example, the vehicle 102 may disable a user interface (UI) or a portion thereof of the electronic devices such that the operator of the vehicle 102 may not be able to input or receive information from the UI if one or more of the thresholds are exceeded. In the same or alternative embodiments, a visual interface of the electronic devices (which may or may not be part of the UI) may display a warning to the operator indicating that the operator should maintain focus on operating the vehicle 102 instead of interacting with the UI if the thresholds are exceeded. In these or other embodiments, at least a portion of the UI of the electronic devices may be enabled in situations when the thresholds may not be exceeded.

As an example, as mentioned above, speed is a safety parameter that may be measured by the sensors 104 of the vehicle 102 that may be used by the vehicle 102 to modify the functionality of the electronic devices associated with the vehicle 102. For example, when the vehicle 102 is travelling at high speeds, the operator may have less time to react to a situation than when the vehicle 102 is travelling at lower speeds. Therefore, distraction of the operator through the use of the electronic devices may be more dangerous at higher speeds than at lower speeds such that the functionality of the electronic devices may be more restricted at higher speeds than at lower speeds. In some embodiments, the restriction may be based on a speed threshold and/or whether or not the vehicle 102 is traveling at or below an indicated speed limit. Additionally, the vehicle 102 may determine based on the speed that the vehicle 102 is not moving such that the vehicle 102 may enable the full functionality of the electronic devices when the vehicle 102 is not moving.

As another example, the sensors 104 of the vehicle 102 may indicate heavy traffic surrounding the vehicle 102, such that it may be unsafe to interact with an electronic device such as, for example, a navigation system, a mobile telephone, etc. Accordingly, the vehicle 102 may temporarily disable use of the electronic device while the vehicle 102 is in the heavy traffic if the amount of traffic detected exceeds a certain traffic threshold. Alternatively, the electronic device may be only partially disabled. For instance, audio media being played back by the electronic device may continue to be played back, while temporarily disabling touch input capabilities of the electronic device and/or alerts associated with incoming communications including text, email, or voice communications.

As mentioned above, another safety parameter that may be used to modify the functionality of the electronic devices associated with the vehicle 102 may be a weather condition. Based on the measurements of the sensors 104, such as, by way of example and not limitation, a thermometer, a rain sensor and/or a snow and ice sensor, the vehicle 102 may be configured to determine the presence of adverse weather conditions. Accordingly, the vehicle 102 may restrict the functionality of the electronic devices associated with the vehicle 102 when adverse weather conditions that may exceed a certain threshold are present such that the operator of the vehicle 102 is less likely to be distracted by the electronic devices while operating the vehicle 102.

In some embodiments, as mentioned above, the vehicle 102 may be configured to determine a road condition such as whether the road is wet, dry, oily and/or icy based on one or more measurements by the sensors 104. Based on the determined road condition, the vehicle 102 may modify the functionality of the electronic devices. For example, if the vehicle 102 determines that the road conditions are wet, oily, and/or icy in a manner that exceeds a certain threshold for these conditions, the functionality of the electronic devices may be more restricted than if the vehicle 102 determines that the road conditions are dry (e.g., when the road conditions are below the associated threshold).

As another example, based on measurements by one or more of the sensors 104, such as an audio sensor configured to detect sirens, the vehicle 102 may determine the proximate location of an emergency vehicle that may be approaching the vehicle 102. The vehicle 102 may modify the functionality of the electronic devices accordingly. For example, the functionality of the electronic devices may be limited such that the operator of the vehicle 102 may be more likely to notice the approach of the emergency vehicle instead of possibly being distracted through interaction with the electronic devices. In some embodiments, the vehicle 102 may be configured to turn down the volume of a media device, such as, for example a radio or video system, such that the operator of the vehicle 102 may be more likely to hear the approaching emergency vehicle and act accordingly. In some embodiments, the vehicle 102 may provide an audio message indicating the approach of the emergency vehicle, or may provide a visual message on a display interface of one or more of the electronic devices that may indicate that an emergency vehicle is approaching. In some embodiments, once the emergency vehicle has passed, the volume may be returned to its previous level.

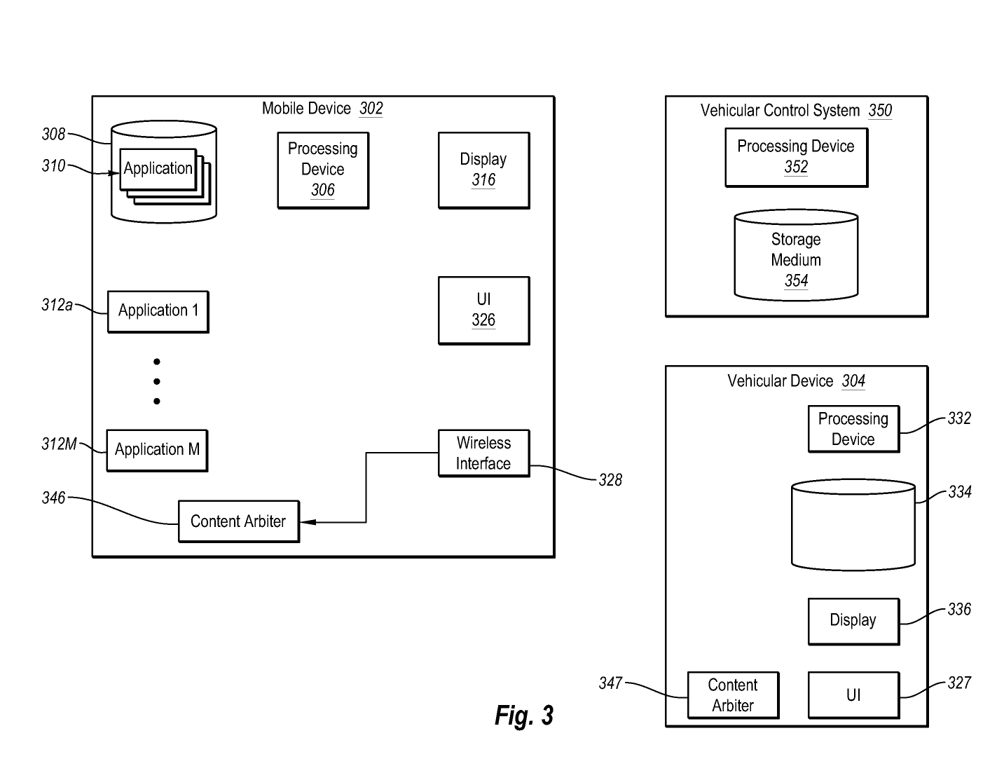

As another example, a GPS measurement may indicate a location of the vehicle 102 and the vehicle 102 may also include a map stored within a control system associated with the vehicle 102 (described in further detail with respect to FIG. 3) indicating that the location associated with the GPS measurement may be within a school zone or other geographical area that may include high risk operating conditions. Accordingly, the vehicle 102 may reduce the functionality of one or more electronic devices based on the vehicle 102 being within a school zone such that the operator of the vehicle 102 may be less likely to be distracted by the electronic devices. In some embodiments, the vehicle 102 may also store or otherwise have access to information regarding laws and/or ordinances that may be associated with the use of electronic devices within the school zone while operating a vehicle and may modify the functionality of the electronic devices associated with the vehicle 102 accordingly.

For example, any use of mobile telephones or other applicable electronic devices within the school zone at certain times may be prohibited by law and the vehicle 102 may have the law stored within the control system of the vehicle 102 or may otherwise have access to the law. Accordingly, after determining that the vehicle 102 is within the school zone, the vehicle 102 may check times and dates against times and dates associated with the law. If the vehicle 102 is travelling through the school zone at one of the indicated times and dates associated with the restricted use of the electronic devices, the vehicle 102 may restrict use of the mobile phone and/or any other applicable electronic device according to the law. In other embodiments, the vehicle 102 may be configured to determine if warning lights associated with the school zone are flashing and may be configured to restrict use of the mobile telephone and/or any other applicable electronic device based on the flashing lights. In some embodiments, once the vehicle 102 has exited the school zone, the previously disabled functionality may be enabled if other safety conditions are met.

As another example, the GPS measurement and maps, and/or other sensors 104 may indicate the type of road that the vehicle 102 is travelling on, such as a two-lane highway, a four-lane divided highway, a six-lane freeway, a winding mountainous road, a residential road, a dirt road, a gravel road, etc. Based on the type of road, the vehicle 102 may modify the functionality of the electronic devices associated with the vehicle 102. For example, if the vehicle 102 is travelling along a winding two-lane mountainous road, the vehicle 102 may be configured to restrict the functionality of the electronic devices more than if the vehicle 102 is travelling along a lightly traveled, relatively straight portion of a four-lane divided highway.

Another safety parameter that may be assessed by the vehicle 102 associated with modifying the use of the electronic devices may be the presence of one or more passengers in the vehicle 102. The sensors 104 of the vehicle 102 may be configured to determine that one or more passengers (hereinafter referred to as “passengers”) are present in the vehicle 102. Even in the presence of other potentially dangerous vehicle operation conditions, the passengers in the vehicle 102 may be able to interact with the electronic devices while the operator of the vehicle 102 may maintain focus on operating the vehicle 102. Accordingly, the vehicle 102 may be configured to modify the functionality of the electronic devices such that the passengers may interact with the electronic devices.

Further, another safety parameter mentioned above that may be used to modify the functionality of the electronic devices may be the proximate location of a pedestrian, a cyclist, another vehicle, a road hazard, a construction cone, a barrier, an animal, etc. The vehicle 102 may accordingly modify the functionality of the electronic devices based on the proximity of the vehicle 102 to any one of these. For example, the sensors 104 of the vehicle 102 may detect that the vehicle 102 is approaching any one of these and may accordingly reduce the functionality of the electronic devices such that the operator may not be distracted by interacting with the electronic devices.

Additionally, the vehicle 102 may enable various features of the electronic devices when the safety parameters indicate that the threats may be below an associated threshold level. For example, if the vehicle 102 is traveling on a six lane highway within the speed limit and there are no other cars on the road, the vehicle 102 may enable some functionality of the electronic devices to allow user input or other functionality that may be restricted in other situations. As another example, as mentioned in some of the examples above, if a high threat situation where the vehicle 102 has restricted some functionality of the electronic devices has passed, the vehicle 102 may enable previously restricted functionality.

Therefore, the vehicle 102 may be configured to dynamically assess one or more safety parameters associated with an operating state of the vehicle 102 and may accordingly modify the functionality of electronic devices associated with the vehicle 102. The vehicle 102 may therefore provide flexibility in the use of the electronic devices while also reducing the dangers associated with interacting with the electronic devices during operation of the vehicle 102.

Modifications, additions, and omissions may be made to the vehicle 102 without departing from the scope of the present disclosure. For example, the specific safety parameters and associated modifications to the functionality of the electronic devices given are merely examples. The vehicle 102 may be configured to modify the functionality of the electronic devices in any applicable manner based on any suitable metric of safety associated with operating the vehicle 102. Further, many examples are given in the context of operating an automobile. However, the functionality of one or more electronic devices associated with other types of vehicles placed in similar or analogous situations may be modified in similar manners. Additionally, although modifications of the functionality of the electronic devices is discussed in the context of individual safety parameters, any combination of safety parameters may be used to determine a modification in the functionality of the electronic devices.

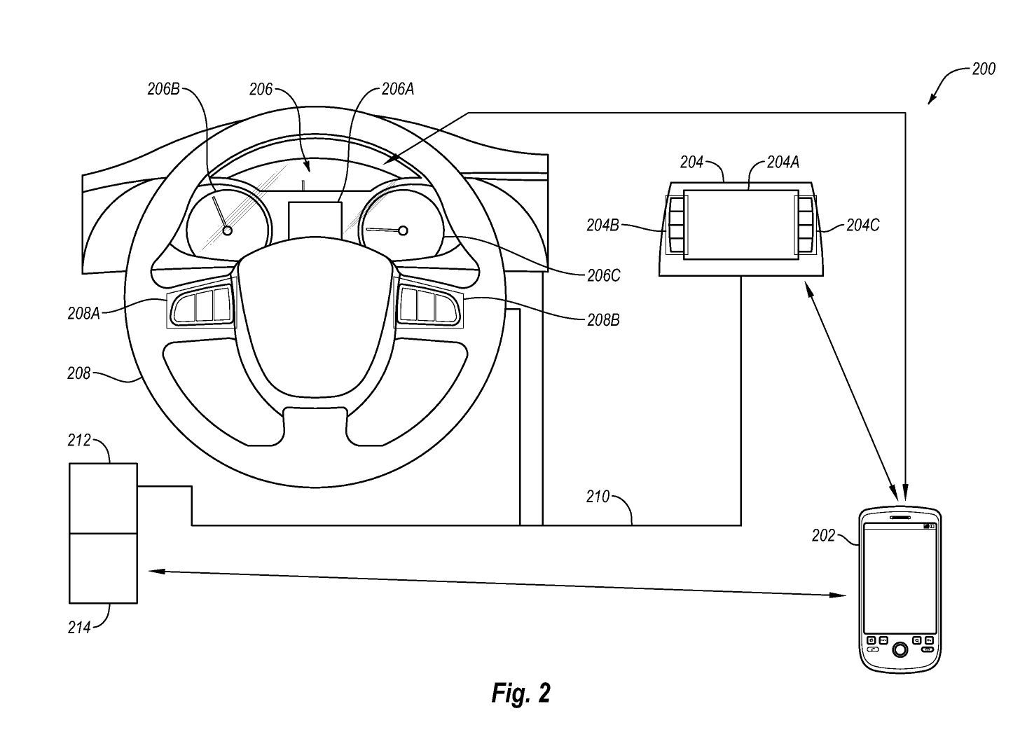

FIG. 2 is a block diagram of a specific embodiment of an operating environment 200 associated with the vehicle 102 of FIG. 1. The environment 200 of FIG. 2 may be located within the interior of the vehicle 102. The environment 200 may include one or more electronic devices associated with the vehicle 102 including a mobile electronic device 202 and vehicular electronic devices such as a head unit 204 and an instrument panel 206.

The mobile device 202 may be virtually any mobile device including, but not limited to, a portable media device, a personal digital assistant (PDA), a smartphone, a tablet computer, a laptop computer, a navigation system, an MP3 player or any other electronic device. According to some embodiments, the mobile device 202 may include a communication interface such as, but not limited to, an IEEE 802.11 interface, a Bluetooth interface, a Universal Mobile Telecommunications System (UMTS) interface or other mobile communication interface.

The mobile device 202 may include a UI that may include any input device configured to receive user input effective to operate the mobile device 202. For example, the UI of the mobile device 202 may include one or more buttons and/or a display of the mobile device 202 that may be implemented as a touchscreen display.

The head unit 204 may include a display 204A configured to display content such as one or more of maps, navigation instructions, video content from an integrated media player (e.g., a Digital Versatile Disk and/or BluRay player), radio or other music information, weather or traffic information, etc. The head unit 204 may additionally include a UI that may include any input device configured to receive user input effective to operate the head unit 204 and potentially other aspects of the vehicle in which the head unit 204 is installed. For example, the UI of the head unit 204 may include one or more buttons 204B, 204C and/or the display 204A itself when implemented as a touchscreen display.

The instrument panel 206 includes at least one display area 206A in which content may be displayed. The instrument panel 206 may include one or more fixed instruments 206B, 206C. For example, the fixed instruments 206B, 206C may include a speedometer, a fuel gauge, a temperature gauge, an RPM gauge, or the like or any combination thereof. Additionally, in some embodiments, the instrument panel 206 may include a UI such as has been described with respect to the head unit 204 that may allow the user to change the content projected on the instrument panel 206.

The UIs of the mobile device 202, the head unit 204 and/or the instrument panel 206 may additionally be configured to output information, alerts, media, or the like. Accordingly, the UIs of the mobile device 202, the head unit 204 and/or the instrument panel 206 may include, but are not limited to, displays, speakers, vibrators, or other suitable output devices. Accordingly, and as described herein, modifying functionality of the electronic devices 202, 204, 206 may include modifying input and/or output functionality of the electronic devices 202, 204, 206.

The environment 200 may further include a steering wheel 208 of the vehicle 102. In some embodiments, the steering wheel 208 may include a UI such as has been described above with respect to the head unit 204 that may be used to control one or more electronic devices of the vehicle 102. For example, the steering wheel 208 may include one or more buttons 208A, 208B. In some embodiments, the buttons 208A, 208B may be used for one or more of speaker volume control, channel selection, track selection, or for other functionality.

In some embodiments, the environment 200 may further include an intra-vehicle bus 210 to which the head unit 204, the instrument panel 206 and/or the steering wheel 208 may be communicatively coupled. The intra-vehicle bus 210 may be configured to allow processing units that may be implemented in each of a vehicular control system of the vehicle 102 (not expressly shown in FIG. 2), the head unit 204, the instrument panel 206 and the steering wheel 208, to communicate with each other. The intra-vehicle bus may include, but is not limited to a controller area network (CAN) bus.

An access node 212 may be provided to allow access to the intra-vehicle bus 210. For example, an intra-vehicle bus interface (IVBI) device 214 may be communicatively coupled to the access node 212 to read data from and/or write data to the intra-vehicle bus 210. In an example embodiment, the access node 212 may include an on-board diagnostics (OBD) connector compliant with a particular OBD interface, such as the OBD-I, OBD-1.5, or OBD-II interfaces. Additionally, the mobile device 202 may be communicatively coupled to the IVBI device 214 via a wired or wireless connection.

In some embodiments, the vehicle 102 may be configured to modify the content displayed at the head unit 204, the instrument panel 206 and/or the mobile device 202 based on one or more assessed safety parameters (hereinafter “assessed safety parameters”) such as those described above with respect to FIG. 1. As described in further detail below, the vehicle 102 may be configured to modify the functionality of the mobile device 202, head unit 204, instrument panel 206, and/or the steering wheel 208 based on instructions sent to the mobile device 202, head unit 204, instrument panel 206, and/or the steering wheel 208 by the vehicular control system via the intra-vehicle bus 210 and/or the IVBI device 214.

In some embodiments, the vehicle 102 may modify the content displayed to notify the operator of the vehicle 102 of safety concerns based on the assessed safety parameters. In the same or alternative embodiments, the vehicle 102 may be configured to modify the functionality of the UI's associated with the head unit 204, the instrument panel 206, the steering wheel 208 and/or the mobile device 202 based on the assessed safety parameters. For example, the vehicle 102 may restrict the functionality of the UI's associated with the head unit 204, the instrument panel 206, the steering wheel 208 and/or the mobile device 202 based on the safety parameters that indicate a potentially dangerous situation such that user input may not be accepted by the UI's. Accordingly, the operator of the vehicle 102 may be less likely to be distracted by the associated electronic device. In these or other embodiments, the vehicle 102 may at least partially enable the functionality of the UI's based on the safety parameters if the safety parameters indicate that use of the UI's may be relatively safe.

Modifications, additions, or omissions may be made to the environment 200 of FIG. 2 without departing from the scope of the present disclosure. For example, the number of electronic devices included in the environment 200 may vary. Additionally, the environment 200 may vary depending on the type of vehicle in which the environment 200 is included.

FIG. 3 is a block diagram of an example vehicular control system 350, mobile device 302 and a vehicular device 304 (hereinafter device 304) that may be implemented in the operating environment 200 of FIG. 2 and vehicle 102 of FIG. 1. For example, the mobile device 302 may correspond to the mobile device 202 of FIG. 2, while the vehicular device 304 may correspond to any of the vehicular devices 204 and 206 of FIG. 2. The mobile device 302 and the vehicular device 304 are examples of electronic devices that may be associated with a vehicle.

The vehicular control system 350 may include a processing device 352 and a computer-readable storage medium 354 (hereinafter “storage medium 354”). The processing device 352 may be configured to execute instructions stored on the storage medium 354 to perform one or more of the operations described herein. For example, the storage medium 354 may include instructions associated with receiving input from one or more sensors 104 of the vehicle 102 and determining one or more safety parameters associated with operating the vehicle 102 based on the received sensor input. In these or other embodiments, the instructions may be associated with determining a risk assessment based on the safety parameters. As mentioned above, in some embodiments, the risk assessment may be based on a threshold associated with the safety parameters that may also be stored in the storage medium 354.

The storage medium 354 may also include other information that may be used to determine the safety parameters; for example, map information, school zone information, laws and ordinances information, or any other information that may be used to determine the safety parameters. Alternately, such other information may be accessed by the vehicular control system 350 remotely from the mobile device 302, the vehicular device 304, or other remote device via a suitable communication interface that may be included in the vehicular control system 350.

The storage medium 354 may include, but is not limited to, a magnetic disk, a flexible disk, a hard-disk, an optical disk such as a compact disk (CD) or DVD, and a solid state drive (SSD) to name a few. Another example of a computer-readable storage medium that may be included in vehicular control system 350 may include a system memory (not shown). Various non-limiting examples of system memory include volatile memory such as random access memory (RAM) or non-volatile memory such as read only memory (ROM), flash memory, or the like or any combination thereof.

The vehicular control system 350 may be configured to communicate instructions to the mobile device 302 and/or the vehicular device 304 such that the functionality of the mobile device 302 and/or the vehicular device 304 may be modified based on the safety parameters. In some embodiments, the vehicular control system 350 may communicate the instructions via an intra-vehicle bus and/or IVBI device—such as the intra-vehicle bus 212 and IVBI device 214 of FIG. 2—that may be communicatively coupled to the vehicular control system 350, mobile device 302, and vehicular device 304.

The mobile device 302 may include a processing device 306 and a computer-readable storage medium 308 (hereinafter “storage medium 308”). The processing device 306 is configured to execute computer instructions stored on the storage medium 308 to perform one or more of the operations described herein, such as operations associated with modifying the functionality of the mobile device 302.

The storage medium 308 may be similar to the storage medium 354 and may include, but is not limited to, a magnetic disk, a flexible disk, a hard-disk, an optical disk such as a compact disk (CD) or DVD, and a solid state drive (SSD) to name a few. Another example of a computer-readable storage medium that may be included in the mobile device 302 may include a system memory (not shown).

One or more applications 310 may be stored in the storage medium 308 and executed by the processing device 306 to become corresponding instantiated applications 312a-312M that generate or render information or content locally or receive information or content from an external information or content source. The instantiated applications 312a-312M may be instantiated and/or controlled via a UI 326 of the mobile device 302. Additionally, the instantiated applications 312a-312M may be configured to output content to a built-in display 316 of the mobile device 302.

The mobile device 302 may also include a wireless interface 328 that may be configured to facilitate wireless communication of data to and from the mobile device 302. Alternately or additionally, other data, including data representing user input, commands and/or other data, may be received from and/or transmitted to corresponding external display devices by the wireless interface 328. The wireless interface 328 may include a Bluetooth wireless interface, a WiFi (or more generally, an IEEE 802.11) wireless interface, or other suitable wireless interface.

In some embodiments, the mobile device 302 may include a content arbiter 346 that may include any suitable combination of software, hardware and/or firmware. The content arbiter 346 may communicate with the vehicular control system 350 via one or more of the wireless interface 328, a wired interface, an intra-vehicle bus, an IVBI device, or any combination thereof. In some embodiments, the content arbiter 346 may receive from the vehicular control system 350 via the IVBI device one or more instructions associated with modifying the functionality of the mobile device 302 based on the safety parameters. The content arbiter 346 may modify the functionality of the mobile device 302 according to the received instructions.

For example, the content arbiter 346 may selectively suppress the content that is displayed on the display 316 of the mobile device 302 based on the safety parameters. Alternately or additionally, the content arbiter 346 may selectively suppress or disable certain functionality of the mobile device 302 depending on the operating state of the vehicle. Examples of the functionality of the mobile device 302 that may be selectively suppressed may include the functionality of a UI 326 of the mobile device 302 to prevent an operator of the vehicle from operating the mobile device 302 via input while operating the vehicle. Additionally, in some embodiments the use of one or more applications 310 and/or instantiated applications 312a-312M may be restricted based on the safety parameters. In some embodiments, the content arbiter 346 may enable various features of the mobile device 302 when the safety parameters indicate that use of the features may be relatively safe, as described above.

The vehicular device 304 may generally include a processing device 332, a computer-readable storage medium 334 (hereinafter “storage medium 334”), a display 336, and a content arbiter 347. The processing device 332 may be configured to execute computer instructions stored on the storage medium 334 to perform one or more of the operations described herein such as operations associated with modifying the functionality of the vehicular device 304. The storage medium 334 may be implemented as any of the types of storage media described above with respect to the storage mediums 308 and 354.

The content arbiter 347 of the vehicular device 304 may be substantially similar to the content arbiter 346 of the mobile device 302. Accordingly, the content arbiter 347 may communicate with the vehicular control system 350 via one or more of an intra-vehicle bus, an IVBI device, a wired or wireless interface, or the like or any combination thereof. In some embodiments, similar to the content arbiter 346 of the mobile device 302, the content arbiter 347 may receive from the vehicular control system 350 one or more instructions associated with modifying the functionality of the vehicular device 304 based on the safety parameters. The content arbiter 347 may modify the functionality of the vehicular device 304 according to the received instructions.

For example, the content arbiter 347 may selectively suppress the content that is displayed on the display 336 of the vehicular device 304 based on instructions associated with the safety parameters that may be received from the vehicular control system 350. In alternative or the same embodiments, the content arbiter 347 may selectively suppress or disable functionality of a UI 327 of the vehicular device 304 based on instructions associated with the safety parameters that may be received from the vehicular control system 350. Additionally, in some embodiments, the content arbiter 347 may enable various features of the vehicular device 304 when the safety parameters indicate that use of the features may be relatively safe.

Accordingly, the functionality of the mobile device 302 and vehicular device 304 may be modified based on the safety parameters assessed by the vehicular control system 350. Therefore, the operator of the vehicle 102 may be less likely to be distracted by the mobile device 302 and the vehicular device 304 during operating conditions that may have elevated levels of danger.

Modifications, additions, or omissions may be made to one or more elements of FIG. 3 without departing from the scope of the present disclosure. For example, the vehicular control system 350, the mobile device 302 and/or the vehicular device 304 may include more or fewer components configured to perform various operations. Additionally, in some embodiments, the mobile device 302 may be configured to project content to the vehicular device 304 such that the display 336 of the vehicular device 304 may display content from the mobile device 302, or vice versa. Additionally, in the same or alternative embodiments, the vehicular device 304 and mobile device 302 may be configured such that the mobile device 302 may be controlled via the UI 327 of the vehicular device 304, or vice versa. Such functionality may also be modified depending on the safety parameters associated with operating the vehicle 102.

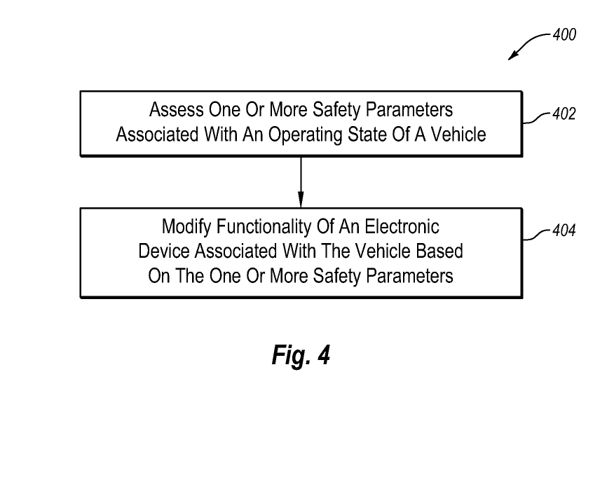

FIG. 4 is a flowchart of an example method 400 for modifying functionality of an electronic device based on one or more safety parameters associated with the operating state of the vehicle. The method 400 and/or variations thereof may be implemented, in whole or in part, by a vehicle such as the vehicle 102 associated with FIGS. 1-3. Alternately or additionally, the method 400 and/or variations thereof may be implemented, in whole or in part, by a processing device executing computer instructions stored on a computer-readable storage medium. Although illustrated as discrete blocks, various blocks may be divided into additional blocks, combined into fewer blocks, or eliminated, depending on the desired implementation.

The method 400 may begin at block 402 in which one or more safety parameters associated with operating a vehicle may be assessed. In some embodiments, the safety parameters may include, but are not limited to, speed of the vehicle, traffic congestion surrounding the vehicle, a weather condition, a road condition, a proximate location of an emergency vehicle, a proximate location of a school zone, road type, presence of a passenger in the vehicle and/or a proximate location of a pedestrian, a cyclist, another vehicle, a road hazard, a construction cone, a barrier, an animal etc. By way of example and not limitation, the one or more safety parameters may be assessed based on measurements made by one or more sensors associated with the vehicle, which sensors may be configured to determine conditions which may include, but are not limited to, a location of the vehicle, a speed of the vehicle, outside temperature surrounding the vehicle, the presence of precipitation, a proximate location of one or more objects with respect to the vehicle (e.g., people, animals, other motorized vehicles, other non-motorized vehicles, road hazards, construction cones, barriers, etc.), a condition of the transportation medium being travelled on (e.g., a wet road, a dry road, a bumpy road, a smooth road, an icy road, an oily road, etc.), or any other applicable condition that may be measured by a sensor.

In block 404, the functionality of one or more electronic devices associated with the vehicle may be modified based on the one or more safety parameters. For example, the functionality of a mobile device inside of the vehicle or a vehicular device integrated with the vehicle may be modified based on the one or more safety parameters. Examples of the modifications of functionality based on the one or more safety parameters are given above with respect to FIG. 1.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. For example, the method 400 may additionally include gathering information using one or more sensors to assess the one or more safety parameters, as described above.

The embodiments described herein may include the use of a special purpose or general-purpose computer including various computer hardware or software modules, as discussed in greater detail below.

Embodiments within the scope of the present disclosure also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method of modifying functionality of an electronic device associated with a vehicle comprising:
assessing one or more safety parameters associated with an operating state of a vehicle; and
modifying functionality of an electronic device associated with the vehicle based on the one or more safety parameters.

2. The method of claim 1, further comprising determining a presence of a potentially dangerous situation associated with the operating state of the vehicle based on the one or more safety parameters.

3. The method of claim 1, further comprising restricting the functionality of the electronic device based on the one or more safety parameters.

4. The method of claim 1, wherein the one or more safety parameters comprise at least one of speed of the vehicle, traffic congestion surrounding the vehicle, a weather condition, a road condition, a proximate location of an emergency vehicle, a proximate location of a school zone, a road type, presence of a passenger in the vehicle, a proximate location of a pedestrian, a proximate location of a cyclist, a proximate location of another vehicle, a proximate location of a road hazard, a proximate location of a construction cone, a proximate location of a barrier and a proximate location of an animal.

5. The method of claim 1, further comprising:
determining whether a passenger is present within the vehicle; and
modifying the functionality of the electronic device based on whether the passenger is present.

6. The method of claim 1, wherein the electronic device comprises a built-in electronic device of the vehicle.

7. The method of claim 1, wherein the electronic device comprises a mobile electronic device.

8. The method of claim 1, wherein modifying the functionality of the electronic device comprises modifying functionality of a user interface of the electronic device.

9. The method of claim 1, further comprising displaying a warning on a user interface of the electronic device based on the one or more safety parameters.

10. The method of claim 1, further comprising analyzing an environment surrounding the vehicle and assessing the one or more safety parameters based on the analysis of the environment.

11. The method of claim 1, further comprising enabling the functionality of the electronic device based on the one or more safety parameters.

12. A processor configured to execute computer instructions to cause a system to perform operations for modifying functionality of an electronic device associated with a vehicle, the operations comprising:
assessing one or more safety parameters associated with an operating state of a vehicle; and
modifying functionality of an electronic device associated with the vehicle based on the one or more safety parameters.

13. The processor of claim 12, wherein the operations further comprise determining a presence of a potentially dangerous situation associated with the operating state of the vehicle based on the one or more safety parameters.

14. The processor of claim 12, wherein the operations further comprise restricting the functionality of the electronic device based on the one or more safety parameters.

15. The processor of claim 12, wherein the one or more safety parameters comprise at least one of speed of the vehicle, traffic congestion surrounding the vehicle, a weather condition, a road condition, a proximate location of an emergency vehicle, a proximate location of a school zone, a road type, presence of a passenger in the vehicle, a proximate location of a pedestrian, a proximate location of a cyclist, a proximate location of another vehicle, a proximate location of a road hazard, a proximate location of a construction cone, a proximate location of a barrier and a proximate location of an animal.

16. The processor of claim 12, wherein the operations further comprise:
determining whether a passenger is present within the vehicle; and
modifying the functionality of the electronic device based on whether the passenger is present.

17. The processor of claim 12, wherein the electronic device comprises a built-in electronic device of the vehicle.

18. The processor of claim 12, wherein the electronic device comprises a mobile electronic device.

19. The processor of claim 12, wherein modifying the functionality of the electronic device comprises modifying functionality of a user interface of the electronic device.

20. The processor of claim 12, wherein the operations further comprise displaying a warning on a user interface of the electronic device based on the one or more safety parameters.

21. The processor of claim 12, wherein the operations further comprise analyzing an environment surrounding the vehicle and assessing the one or more safety parameters based on the analysis of the environment.

22. The processor of claim 12, wherein the operations further comprise enabling the functionality of the electronic device based on the one or more safety parameters.
